(19) United States
(12) Patent Application Publication
(10) Pub. No.: US 2010/0194633 A1
(43) Pub. Date: Aug. 5, 2010

(54) POSITION CALCULATING METHOD AND POSITION CALCULATING DEVICE

(75) Inventor: Yoshitaka YAMAGATA, Shiojiri (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/640,772

(22) Filed: Dec. 17, 2009

(30) Foreign Application Priority Data
Jan. 30, 2009 (JP) 2009-019197

(51) Int. Cl. G01S 19/13

(52) U.S. Cl. 342/357.05

(57) ABSTRACT

A position calculating method includes: calculating the satellite position of a positioning satellite on the basis of satellite orbit information in an orthogonal coordinate system having the Earth center as the origin; detecting a Doppler frequency by receiving a positioning signal from the positioning satellite; and calculating the position of a position calculating device using the satellite positions of the plurality of positioning satellites and the Doppler frequency in a spherical coordinate system in which the Earth center is the origin and a distance from the Earth center to the Earth's surface is a radius vector.

### CROSS-REFERENCE

The entire disclosure of Japanese Patent Application No. 2009-019197, filed Jan. 30, 2009 is expressly incorporated by reference herein.

### BACKGROUND

1. Technical Field

The present invention relates to a position calculating method and a position calculating device.

2. Related Art

A GPS (global positioning system) is widely known as a positioning system using a positioning signal and is used for a position calculating device built into a mobile phone, a car navigation apparatus, or the like. The GPS performs a position calculation operation for calculating the three-dimensional coordinate values, which indicate the position of the GPS, and a time error on the basis of the information, such as the positions of a plurality of GPS satellites or a pseudo distance from each GPS satellite to the GPS.

Generally, although the position calculation is performed using the pseudo distance in many cases, the information on the initial position which is reliable to some extent is required in order to perform the position calculation using the pseudo distance. However, there is a case where the information on the initial position cannot be used such as the case where the position calculation is first performed after power has been supplied to a position calculating device. Also in this case, a method for performing the position calculation is required. As an example, JP-A-2000-235067 discloses a method of performing position calculation using the Doppler frequency of a positioning signal.

Ideally, according to the position calculating method disclosed in JP-A-2000-235067, the exact position can be calculated. However, it was difficult to easily apply the position calculating method to the product including the position calculating device.

### SUMMARY

An advantage of some aspects of the invention is to propose a new method for performing position calculation using a Doppler frequency.

According to a first aspect of the invention, there is provided a position calculating method including: calculating the satellite position of a positioning satellite on the basis of satellite orbit information in an orthogonal coordinate system having the Earth center as the origin; detecting a Doppler frequency by receiving a positioning signal from the positioning satellite; and calculating the position of a position calculating device using the satellite positions of the plurality of positioning satellites and the Doppler frequency in a spherical coordinate system in which the Earth center is the origin and a distance from the Earth center to the Earth's surface is a magnitude of a radius vector.

Furthermore, according to another aspect of the invention, there is provided a position calculating device including: a satellite position calculating section that calculates the satellite position of a positioning satellite on the basis of satellite orbit information in an orthogonal coordinate system having the Earth center as the origin; a Doppler detecting section that detects a Doppler frequency by receiving a positioning signal from the positioning satellite; and a position calculating section that calculates the position of a position calculating device using the satellite positions of the plurality of positioning satellites and the Doppler frequency in a spherical coordinate system in which the Earth center is the origin and a distance from the Earth center to the Earth's surface is a radius vector.

According to the aspects of the invention, the satellite position of the positioning satellite is calculated on the basis of the satellite orbit information in the orthogonal coordinate system having the Earth center as the origin. In addition, a Doppler frequency is detected by receiving a positioning signal from the positioning satellite, and the position of the position calculating device is calculated using the satellite position of each of the plurality of positioning satellites and the Doppler frequency in the spherical coordinate system in which the Earth center is the origin and the distance from the Earth center to the Earth's surface is a radius vector.

By calculating the angle of declination as an unknown parameter in the spherical coordinate system in which the Earth center is the origin and the distance from the Earth center to the Earth's surface is a radius vector, it becomes possible to appropriately calculate the position of the user with a small number of satellites. In addition, this position calculating method can be easily applied to the product including the position calculating device.

According to a second aspect of the invention, there may be provided the position calculating method of the first aspect, which further includes: calculating the velocity of the positioning satellite on the basis of the satellite orbit information in the orthogonal coordinate system; and calculating the velocity of the position calculating device in the orthogonal coordinate system using the satellite position and velocity of the positioning satellite and the Doppler frequency.

In the second aspect of the invention, the velocity of the positioning satellite is calculated on the basis of the satellite orbit information in the spherical coordinate system. In addition, the velocity of the position calculating device are calculated in the orthogonal coordinate system using the satellite position and velocity of each positioning satellite and the Doppler frequency. Accordingly, it becomes possible to calculate not only the position of the position calculating device but also the velocity.

According to a third aspect of the invention, there may be provided the position calculating method of the first aspect, wherein the calculating of the velocity of the position calculating device is performed assuming that the radial component of the velocity of the position calculating device is zero.

In the third aspect of the invention, the velocity of the position calculating device are calculated assuming that the radial component is zero. By performing the position calculation under conditions in which such constraints are set, it becomes possible to reduce the number of unknown parameters. As a result, the number of satellites required for the position calculation can be reduced or the amount of operations can be reduced.

According to a fourth aspect of the invention, there may be provided the position calculating method of the second or third aspect, which further includes: calculating the position of the position calculating device, which is an unknown quantity, on the basis of the detected Doppler frequency and a calculation expression of a theoretical Doppler frequency which uses, under conditions in which the distance from the Earth center to the Earth's surface is a radius vector, the satellite position and velocity of the positioning satellite, the position of the position calculating device which is the unknown quantity expressed in the spherical coordinate system, and velocity of the position calculating device which are unknown quantities expressed in the orthogonal coordinate system.

In the fourth aspect of the invention, the position of the position calculating device, which is an unknown quantity, is calculated on the basis of the detected Doppler frequency and the calculation expression of a theoretical Doppler frequency using the satellite position and velocity of each positioning satellite, the position of the position calculating device which is the unknown quantity expressed in the spherical coordinate system, and velocity of the position calculating device which are unknown quantities expressed in the orthogonal coordinate system.

The Doppler frequency calculated from the calculation expression of the theoretical Doppler frequency should be equal to the Doppler frequency that was actually detected. On the basis of such relationship, the position of the position calculating device can be calculated by solving simultaneous equations with the position of the position calculating device as an unknown quantity.

According to a fifth aspect of the invention, there may be provided the position calculating method of the fourth aspect, wherein clock drift of the position calculating device is further used in the calculating of the position of the position calculating device.

In the fifth aspect of the invention, it becomes possible to calculate the position of the position calculating device using the calculation expression of the Doppler frequency in which the clock drift of the position calculating device is considered. As a result, the accuracy in the position calculation is improved.

According to a sixth aspect of the invention, there may be provided the position calculating method of any of the first to fifth aspects of the invention, which further includes: calculating the final position by performing predetermined position calculation processing based on the received positioning signal using the position of the position calculating device as the initial position.

In the sixth aspect of the invention, the final position is calculated by performing the position calculation processing based on the received positioning signal using the position of the position calculating device, which is calculated by the above-described position calculating method, as the initial position. If a convergence operation using, for example, the least square method is performed as the position calculation, it prevents the incorrect converging of the solution. As a result, it becomes possible to calculate the position of the position calculating device with high precision.

### BRIEF DESCRIPTION OF THE DRAWINGS

The invention will be described with reference to the accompanying drawings, wherein like numbers reference like elements.

FIG. 1 is a view showing a spherical coordinate system.

FIG. 2 is view showing a Doppler frequency.

FIG. 3 is a block diagram illustrating the functional configuration of a mobile phone.

FIG. 4 is a view illustrating an example of data stored in a ROM.

FIG. 5 is a view showing an example of data stored in a flash ROM.

FIG. 6 is a view showing an example of data stored in a RAM.

FIG. 7 is a view showing an example of the data configuration of measurement data.

FIG. 8 is a flow chart showing the flow of main processing.

FIG. 9 is a flow chart illustrating the flow of position calculation processing.

FIG. 10 is a flow chart showing the flow of Doppler using position calculation processing.

FIG. 11 is a flow chart showing the flow of second position calculation processing.

### DESCRIPTION OF EXEMPLARY EMBODIMENTS

Hereinafter, an embodiment when the invention is applied to a mobile phone 1, which is a kind of electronic apparatus including a position calculating device, will be described with reference to the accompanying drawings. In addition, the mobile phone 1 moves by being carried by the user. Accordingly, in the present embodiment, various directions detected by the mobile phone 1 will be described as directions of the user. In addition, embodiments to which the invention can be applied are not limited to the embodiment to be described below.

### 1. Principles

### 1-1. Definition of Variables

First, variables used in the present embodiment will be defined. A position vector of the mobile phone 1 in a terrestrial coordinate system which is an orthogonal coordinate system is expressed as a three-dimensional vector pᵤ shown in the following Expression (1), and a position vector of an i-th GPS satellite is expressed as a three-dimensional vector P_{SVi} shown in the following Expression (2). In this case, a vector in the line of sight Sᵢ from the i-th GPS satellite toward the mobile phone 1 is expressed by the following Expression (3).

\vec{p}ᵤ=[pᵤₓ, p_{uy}, p_{uz}]^{T} (1)

\vec{p}_{SVi}=[p_{SVix}, p_{SViy}, p_{SViz}]^{T} (2)

\vec{S}ᵢ=\vec{p}_{SVi}−\vec{p}ᵤ (3)

In addition, a moving speed vector (velocity) including the moving speed and moving direction of the mobile phone 1 in the orthogonal coordinate system having the earth center as the origin is expressed as a three-dimensional vector vᵤ shown in the following Expression (4), and a moving speed vector of the i-th GPS satellite is expressed as a three-dimensional vector v_{SVi} shown in the following Expression (5). In this case, a relative speed vector Vᵢ between the i-th GPS satellite and the mobile phone 1 is expressed by the following Expression (6).

\vec{v}ᵤ=[vᵤₓ, v_{uy}, v_{uz}]^{T} (4)

\vec{v}_{SVi}=[v_{SVix}, v_{SViy}, v_{SViz}]^{T} (5)

\vec{V}ᵢ=\vec{v}_{SVi}−\vec{v}ᵤ (6)

In addition, a Doppler frequency of a GPS satellite signal that the mobile phone 1 has actually received from the i-th GPS satellite is expressed as f_{DOPi}. Moreover, a Doppler frequency that is theoretically calculated assuming that a GPS satellite signal from the i-th GPS satellite has been received at the position pᵤ is expressed as f_{CALi}. In addition, clock drift of the mobile phone 1 is expressed as d.

### 1-2. Transformation to Spherical Coordinate System

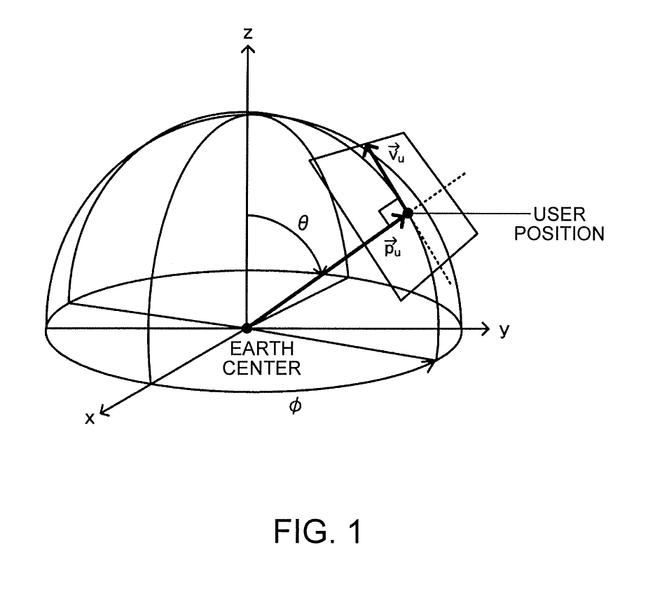

In the present embodiment, the position vector pᵤ of the mobile phone 1 in the terrestrial coordinate system is transformed to a position vector in the spherical coordinate system having the earth center as the origin. Specifically, a spherical coordinate system having three axes of an x axis, a y axis, and a z axis shown in FIG. 1 is considered, and the position vector pᵤ of the mobile phone 1 is transformed by using the following Expression (7).

$${\vec{p}}_{u} = [ \begin{matrix}{p}_{ux} \\ {p}_{uy} \\ {p}_{yz}\end{matrix} ] = R [ \begin{matrix}sin θ cos φ \\ sin θ sin φ \\ cos θ\end{matrix} ] \qquad ( 7 )$$

In the Expression (7), R is a radius vector and is expressed by the following Expression (8). In addition, θ and φ are angles of declination and are expressed by the following Expressions (9) and (10), respectively.

$$\begin{matrix}R = \sqrt{{p}_{ux}^{2} + {p}_{uy}^{2} + {p}_{uz}^{2}} & ( 8 ) \\ θ = arccos ( \frac{{p}_{uz}}{R} ) & ( 9 ) \\ φ = arctan ( \frac{{p}_{uy}}{{p}_{ux}} ) & ( 10 )\end{matrix}$$

In the present embodiment, the radius vector R is assumed to be a fixed value. For example, the distance from the earth center to the earth's surface (for example, 0 meter above sea level) may be set as the radius vector R. Accordingly, unknown quantities regarding the user's position are the two angles of declination, θ and φ.

### 1-3. Constraint Condition of Moving Speed

In the present embodiment, the constraint condition of the moving speed vector of the mobile phone 1 is set. Specifically, it is assumed that the mobile phone 1 does not move in the altitude direction and the moving speed vector vᵤ of the mobile phone 1 is limited within the tangential plane of the position expressed by the position vector pᵤ as shown in FIG. 1. That is, the calculation is performed assuming that the radial component of a moving speed vector in the spherical coordinate system is zero.

In this case, since the moving speed vector vᵤ and position vector pᵤ of the mobile phone 1 are perpendicular to each other, the following Expression (11) is obtained.

$$\begin{matrix}0 = {\vec{v}}_{u} \cdot {\vec{p}}_{u} \\ = {v}_{ux} {p}_{ux} + {v}_{uy} {p}_{uy} + {v}_{uz} {p}_{uz}\end{matrix} \qquad ( 11 )$$

In addition, by solving the Expression (11) for v_{uz} and substituting it into the Expression (7), the following Expression (12) is derived.

$$\begin{matrix}{v}_{uz} = - \frac{1}{{p}_{uz}} ( {v}_{ux} {p}_{ux} + {v}_{uy} {p}_{uy} ) \\ = - \frac{1}{R cos θ} ( {v}_{ux} R sin θ cos φ + {v}_{uy} R sin θ sin φ ) \\ = - tan θ ( {v}_{ux} cos φ + {v}_{uy} sin φ )\end{matrix} \qquad ( 12 )$$

Due to the constraint that the moving speed vector vᵤ and the position vector pᵤ are perpendicular to each other, any one of the three components (vᵤₓ, v_{uy}, v_{uz}) of the moving speed vector vᵤ can be eliminated.

### 1-4. Doppler Frequency

Viewed from the dimension of the moving speed, the theoretical Doppler Frequency F_{CALi} when a GPS satellite signal from the i-th GPS satellite is received at the position expressed by the position vector pᵤ of the mobile phone 1 is a component in the line of sight of the relative speed between the i-th GPS satellite and the mobile phone 1.

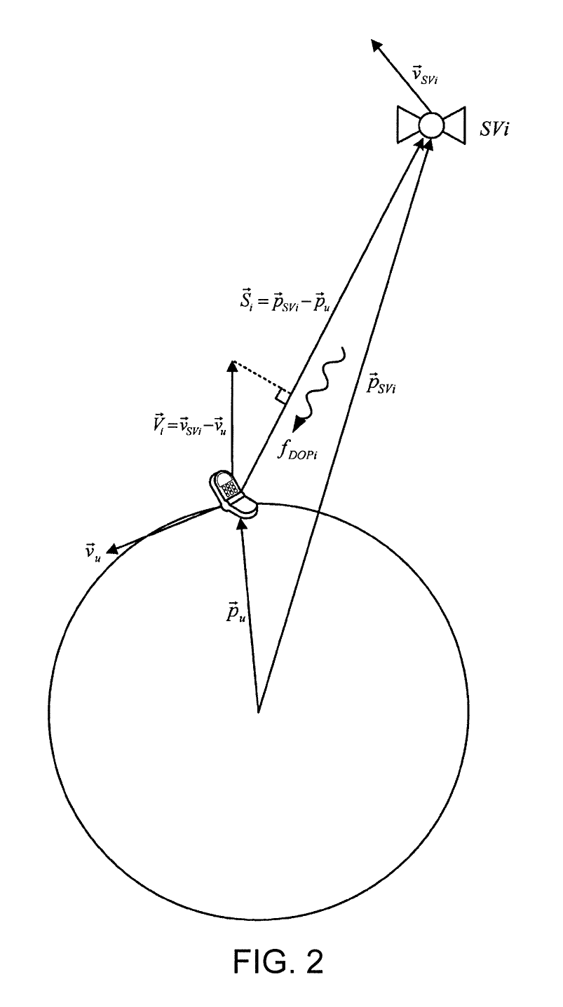

Specifically, by projecting the relative speed vector Vᵢ in a direction of the vector in the line of sight Sᵢ in the positional relationship between the mobile phone 1 and the i-th GPS satellite SVi shown in FIG. 2, the theoretical Doppler frequency f_{CALi} can be calculated by using the following Expression (13).

$$\begin{matrix}{f}_{CALi} = \frac{{\vec{p}}_{SVi} - {\vec{p}}_{u}}{\vert {\vec{p}}_{SVi} - {\vec{p}}_{u} \vert} \cdot ( {\vec{v}}_{SVi} - {\vec{v}}_{u} ) \\ = \frac{\begin{matrix}( {p}_{SVix} - {p}_{ux} ) ( {v}_{SVix} - {v}_{ux} ) + ( {p}_{SViy} - {p}_{uy} ) ( {v}_{SViy} - {v}_{uy} ) + \\ ( {p}_{SViz} - {p}_{uz} ) ( {v}_{SViz} - {v}_{uz } )\end{matrix}}{\sqrt{{( {p}_{SVix} - {p}_{ux} )}^{2} + {( {p}_{SViy} - {p}_{uy} )}^{2} + {( {p}_{SViz} - {p}_{uz} )}^{2}}}\end{matrix} \qquad ( 13 )$$

However, since there is a clock drift in the mobile phone 1, the Doppler frequency f_{DOPi} of a GPS satellite signal that the mobile phone 1 actually receives from the i-th GPS satellite becomes equal to that obtained by adding a clock drift d to the theoretical Doppler frequency f_{CALi} calculated from the Expression (13). Accordingly, the following Expression (14) is obtained.

f_{DOPi}=f_{CALi}(φ, θ, vᵤₓ, v_{uy})+d (14)

In the Expression (14), f_{DOPi} is known because it is the Doppler frequency of a GPS satellite signal that the mobile phone 1 actually receives. In addition, the position vector P_{SVi} and moving speed vector V_{SVi} of the GPS satellite are known because they can be calculated using the satellite orbit information (for example, ephemeris). Therefore, unknown parameters in the Expression (14) are the position vector pᵤ, moving speed vector vᵤ, and clock drift d of the mobile phone 1.

Since the position vector pᵤ is expressed in the spherical coordinate system as described above and the radius R is a fixed value, there are two unknown parameters, the angles of declination θ and φ. In addition, since v_{uz} can be eliminated by the Expression (11) or (12), for example, although the moving speed vector vᵤ includes the three components vᵤₓ, v_{uy}, and v_{uz}, there are two unknown parameters, vᵤₓ and v_{uy}. As a result, there are a total of five unknown parameters, φ, θ, vᵤₓ, v_{uy}, and d.

When considered in the terrestrial coordinate system, there exist seven unknown parameters, (pᵤₓ, p_{uy}, p_{uz}) which is the three-dimensional position of the user, (vᵤₓ, v_{uy}, v_{uz}) which is the three-dimensional moving speed, and the clock drift d. Accordingly, since it is necessary to perform the calculation by capturing at least seven GPS satellites, this is not realistic when the receiving environment of GPS satellite signals or the processing load of the processor is taken into consideration. In the method of the present embodiment, however, it is possible to calculate the position, moving speed, and moving direction of the user by performing the calculation by capturing at least five GPS satellites. Accordingly, even if the receiving environment of GPS satellite signals becomes worse, the position calculation can be performed. As a result, the processing load of the processor is also reduced.

Solving the Expression (14) is equivalent to solving the following Expression (15). That is, solving the Expression (14) is equal to calculating φ, θ, vᵤₓ, v_{uy}, and d which satisfy “F(φ, θ, vᵤₓ, v_{uy}, d)=0” when (left side)−(right side) in the Expression (14) is assumed to be “F(φ, θ, vᵤₓ, v_{uy}, d)”. In the present embodiment, the numerical solution of Expression (15) is calculated using the Newton's method.

Fᵢ(φ, θ, vᵤₓ, v_{uy}, d)=f_{DOPi}−f_{CALi}(φ, θ, vᵤₓ, v_{uy})−d= (15)

### 1-5. Newton's Method

Now, it will be considered to approximately calculate the value of an unknown parameter x, which satisfies “F(x)=0” by a computer using the Newton's method. When steps of repeated calculation in the Newton's method are expressed as “1, 2, 3, . . . , n, . . . ”, the value xₙ of an unknown parameter in step n may be expressed by using the following Expression (16) using the value xₙ₋₁ of an unknown parameter in step n-1 and the update amount Δx.

xₙ=xₙ₋₁−Δx (16)

In this case, F(xₙ) which is the value of a function F(x) in step n is expressed as “F(xₙ₋₁−Δx)” by substituting the Expression (16). By performing Taylor expansion of this function up to the primary term around “x=xₙ₋₁”, the following Expression (17) is obtained.

$$\begin{matrix}F ( {x}_{n} ) = F ( {x}_{n - 1} - Δ x ) \\ = F ( {x}_{n - 1} ) - \frac{\partial F ( {x}_{n - 1} )}{\partial x} Δ x \\ = 0\end{matrix} \qquad ( 17 )$$

The following Expression (18) is obtained by solving the Expression (17) for the update amount Δx.

$$Δ x = {( \frac{\partial F ( {x}_{n - 1} )}{\partial x} )}^{- 1} F ( {x}_{n - 1} ) \qquad ( 18 )$$

The suitable initial value is set for x and the update amount Δx is calculated according to Expression (18), and x is updated using the calculated update amount Δx. By repeating this step, xₙ satisfying “F(xₙ)=0” can be approximately calculated. The Expression (15) can be solved by extending this idea to the fifth dimension.

In this case, the Expression (17) may be expressed like the following Expression (19). In addition, matrices F, H, and Δx in Expression (19) are expressed like the following Expressions (20) to (22), respectively.

$$\begin{matrix}F - H Δ x = 0 & ( 19 ) \\ F = [ \begin{matrix}{F}_{1} ( φ , θ , {v}_{ux} , {v}_{uy} , d ) \\ {F}_{2} ( φ , θ , {v}_{ux} , {v}_{uy} , d ) \\ ⋮ \\ {F}_{i} ( φ , θ , {v}_{ux} , {v}_{uy} , d ) \\ ⋮\end{matrix} ] & ( 20 ) \\ H = [ \begin{matrix}\frac{\partial {F}_{1}}{\partial φ} & \frac{\partial {F}_{1}}{\partial θ} & \frac{\partial {F}_{1}}{\partial {v}_{ux}} & \frac{\partial {F}_{1}}{\partial {v}_{uy}} & \frac{\partial {F}_{1}}{\partial d} \\ \frac{\partial {F}_{2}}{\partial φ} & \frac{\partial {F}_{2}}{\partial θ} & \frac{\partial {F}_{2}}{\partial {v}_{ux}} & \frac{\partial {F}_{2}}{\partial {v}_{uy}} & \frac{\partial {F}_{2}}{\partial d} \\ & & ⋮ & & \\ \frac{\partial {F}_{i}}{\partial φ} & \frac{\partial {F}_{i}}{\partial θ} & \frac{\partial {F}_{i}}{\partial {v}_{ux}} & \frac{\partial {F}_{i}}{\partial {v}_{uy}} & \frac{\partial {F}_{i}}{\partial d} \\ & & ⋮ & & \end{matrix} ] & ( 21 ) \\ Δ x = [ \begin{matrix}Δ φ \\ Δ θ \\ Δ {v}_{ux} \\ Δ {v}_{uy} \\ Δ d\end{matrix} ] & ( 22 )\end{matrix}$$

Components obtained by performing partial differentials of the matrix F with respect to φ, θ, vᵤₓ, v_{uy}, and d, which are unknown parameters, are included in the matrix H. Since these components can be acquired by mathematical calculation, the specific calculation result will not be explained.

### 1-6. Elimination of Clock Drift

The result obtained by performing a partial differential of “Fᵢ” among the components included in the matrix H with respect to the clock drift d is −1. That is, the following Expression (23) is obtained.

$$\frac{\partial {F}_{i}}{\partial d} = - 1 \qquad ( 23 )$$

Using the Expression (23), the term of clock drift can be eliminated. Specifically, the average value F_{AVE} of all Fᵢ is first calculated according to the following Expression (24).

$${F}_{AVE} = \frac{1}{N} {\sum }_{i = 1}^{N} {F}_{i} \qquad ( 24 )$$

Here, N is the number of captured GPS satellites.

In addition, a matrix F′ shown in the following Expression (25) is obtained by subtracting F_{AVE} from Fᵢ in each satellite.

$${F}^{′} = [ \begin{matrix}{F}_{1} ( φ , θ , {v}_{ux} , {v}_{uy} , d ) - {F}_{AVE} \\ {F}_{2} ( φ , θ , {v}_{ux} , {v}_{uy} , d ) - {F}_{AVE} \\ ⋮ \\ {F}_{i} ( φ , θ , {v}_{ux} , {v}_{uy} , d ) - {F}_{AVE} \\ ⋮\end{matrix} ] \qquad ( 25 )$$

In addition, the term of clock drift is eliminated by subtracting a result, which is obtained by performing partial differential of the average value F_{AVE} obtained in Expression (24) with respect to the corresponding parameter, from each corresponding component included in the matrix H. Specifically, H shown in Expression (21) is transformed to H′ shown in the following Expression (26).

$$\begin{matrix}{H}^{′} = [ \begin{matrix}\frac{\partial {F}_{1}}{\partial φ} - \frac{\partial {F}_{AVE}}{\partial φ} & \frac{\partial {F}_{1}}{\partial θ} - \frac{\partial {F}_{AVE}}{\partial θ} & \frac{\partial {F}_{1}}{\partial {v}_{ux}} - \frac{\partial {F}_{AVE}}{\partial {v}_{ux }} & \frac{\partial {F}_{1}}{\partial {v}_{uy}} - \frac{\partial {F}_{AVE}}{\partial {v}_{uy }} & \frac{\partial {F}_{1}}{\partial d} - \frac{\partial {F}_{AVE}}{\partial d} \\ \frac{\partial {F}_{2}}{\partial φ} - \frac{\partial {F}_{AVE}}{\partial φ} & \frac{\partial {F}_{2}}{\partial θ} - \frac{\partial {F}_{AVE}}{\partial θ} & \frac{\partial {F}_{2}}{\partial {v}_{ux}} - \frac{\partial {F}_{AVE}}{\partial {v}_{ux}} & \frac{\partial {F}_{2}}{\partial {v}_{uy}} - \frac{\partial {F}_{AVE}}{\partial {v}_{uy}} & \frac{\partial {F}_{2}}{\partial d} - \frac{\partial {F}_{AVE}}{\partial d} \\ & & ⋮ & & \\ \frac{\partial {F}_{i}}{\partial φ} - \frac{\partial {F}_{AVE}}{\partial φ} & \frac{\partial {F}_{i}}{\partial θ} - \frac{\partial {F}_{AVE}}{\partial θ} & \frac{\partial {F}_{i}}{\partial {v}_{ux}} - \frac{\partial {F}_{AVE}}{\partial {v}_{ux}} & \frac{\partial {F}_{i}}{\partial {v}_{uy}} - \frac{\partial {F}_{AVE }}{\partial {v}_{uy}} & \frac{\partial {F}_{i}}{\partial d} - \frac{\partial {F}_{AVE}}{\partial d} \\ & & ⋮ & & \end{matrix} ] \\ = [ \begin{matrix}\frac{\partial {F}_{1}}{\partial φ} - \frac{\partial {F}_{AVE}}{\partial φ} & \frac{\partial {F}_{1}}{\partial θ} - \frac{\partial {F}_{AVE}}{\partial θ} & \frac{\partial {F}_{1}}{\partial {v}_{ux}} - \frac{\partial {F}_{AVE}}{\partial {v}_{ux}} & \frac{\partial {F}_{1}}{\partial {v}_{uy}} - \frac{\partial {F}_{AVE}}{\partial {v}_{uy}} & 0 \\ \frac{\partial {F}_{2}}{\partial φ} - \frac{\partial {F}_{AVE}}{\partial φ} & \frac{\partial {F}_{2}}{\partial θ} - \frac{\partial {F}_{AVE}}{\partial θ} & \frac{\partial {F}_{2}}{\partial {v}_{ux}} - \frac{\partial {F}_{AVE}}{\partial {v}_{ux}} & \frac{\partial {F}_{2}}{\partial {v}_{uy}} - \frac{\partial {F}_{AVE}}{\partial {v}_{uy}} & 0 \\ & & ⋮ & & \\ \frac{\partial {F}_{i}}{\partial φ} - \frac{\partial {F}_{AVE}}{\partial φ} & \frac{\partial {F}_{i}}{\partial θ} - \frac{\partial {F}_{AVE}}{\partial θ} & \frac{\partial {F}_{i}}{\partial {v}_{ux}} - \frac{\partial {F}_{AVE}}{\partial {v}_{ux}} & \frac{\partial {F}_{i}}{\partial {v}_{uy}} - \frac{\partial {F}_{AVE}}{\partial {v}_{uy}} & 0 \\ & & ⋮ & & \end{matrix} ] \\ = [ \begin{matrix}\frac{\partial {F}_{1}}{\partial φ} - \frac{\partial {F}_{AVE}}{\partial φ} & \frac{\partial {F}_{1}}{\partial θ} - \frac{\partial {F}_{AVE}}{\partial θ} & \frac{\partial {F}_{1}}{\partial {v}_{ux}} - \frac{\partial {F}_{AVE}}{\partial {v}_{ux}} & \frac{\partial {F}_{1}}{\partial {v}_{uy}} - \frac{\partial {F}_{AVE}}{\partial {v}_{uy}} \\ \frac{\partial {F}_{2}}{\partial φ} - \frac{\partial {F}_{AVE}}{\partial φ} & \frac{\partial {F}_{2}}{\partial θ} - \frac{\partial {F}_{AVE}}{\partial θ } & \frac{\partial {F}_{2}}{\partial {v}_{ux}} - \frac{\partial {F}_{AVE}}{\partial {v}_{ux}} & \frac{\partial {F}_{2}}{\partial {v}_{uy}} - \frac{\partial {F}_{AVE}}{\partial {v}_{uy}} \\ & ⋮ & & \\ \frac{\partial {F}_{i}}{\partial φ} - \frac{\partial {F}_{AVE}}{\partial φ} & \frac{\partial {F}_{i}}{\partial θ} - \frac{\partial {F}_{AVE}}{\partial θ} & \frac{\partial {F}_{i}}{\partial {v}_{ux}} - \frac{\partial {F}_{AVE}}{\partial {v}_{ux}} & \frac{\partial {F}_{i}}{\partial {v}_{uy}} - \frac{\partial {F}_{AVE}}{\partial {v}_{uy}} \\ & ⋮ & & \end{matrix} ]\end{matrix} \qquad ( 26 )$$

Here, the results obtained by performing partial differentials of F_{AVE} with respect to φ, θ, vᵤₓ, v_{uy}, and d, which are unknown parameters, are given by the following Expressions (27) to (31), respectively.

$$\begin{matrix}\frac{\partial {F}_{AVE}}{\partial φ} = \frac{1}{N} {\sum }_{i = 1}^{N} \frac{\partial {F}_{i}}{\partial φ} & ( 27 ) \\ \frac{\partial {F}_{AVE}}{\partial θ} = \frac{1}{N} {\sum }_{i = 1}^{N} \frac{\partial {F}_{i}}{\partial θ} & ( 28 ) \\ \frac{\partial {F}_{AVE}}{\partial {v}_{ux}} = \frac{1}{N} {\sum }_{i = 1}^{N} \frac{\partial {F}_{i}}{\partial {v}_{ux}} & ( 29 ) \\ \frac{\partial {F}_{AVE}}{\partial {v}_{uy}} = \frac{1}{N} {\sum }_{i = 1}^{N} \frac{\partial {F}_{i}}{\partial {v}_{uy}} & ( 30 ) \\ \frac{\partial {F}_{AVE}}{\partial d} = \frac{1}{N} {\sum }_{i = 1}^{N} \frac{\partial {F}_{i}}{\partial d} = \frac{1}{N} \cdot ( - N ) = - 1 & ( 31 )\end{matrix}$$

From the Expressions (23) and (31), it can be seen that all components in the far right column of the matrix H′ become 0. That is, all components of clock drift become 0. Accordingly, since the calculation can be performed under conditions in which the term of clock drift is eliminated, the equation to be solved arrives at the following equation (32).

F′=H′Δx′ (32)

Here, Δx′ is given by the following Expression (33).

$$Δ {x}^{′} = [ \begin{matrix}Δ φ \\ Δ θ \\ Δ {v}_{ux} \\ Δ {v}_{uy}\end{matrix} ] \qquad ( 33 )$$

Thus, by eliminating the term of clock drift so that the calculation can be performed under conditions in which one order is reduced, the amount of operations is decreased. As a result, the processing load of the processor can be reduced. Moreover, although the information on the initial position which is reliable to some extent is needed to calculate the position of the user in the position calculation using a pseudo distance, the position calculation using the Doppler frequency of the present embodiment is advantageous in that the information on the initial position is not needed.

The inventor of this application actually performed the convergence calculation based on the Newton's method using the Expression (32) under conditions in which all initial values of the unknown parameters φ, θ, vᵤₓ, and v_{uy} are set to 0. As a result, the inventor confirmed that there was converging on a suitable solution with the number of repetitions of about four or five times, without incorrect convergence.

### 2. Functional Configuration

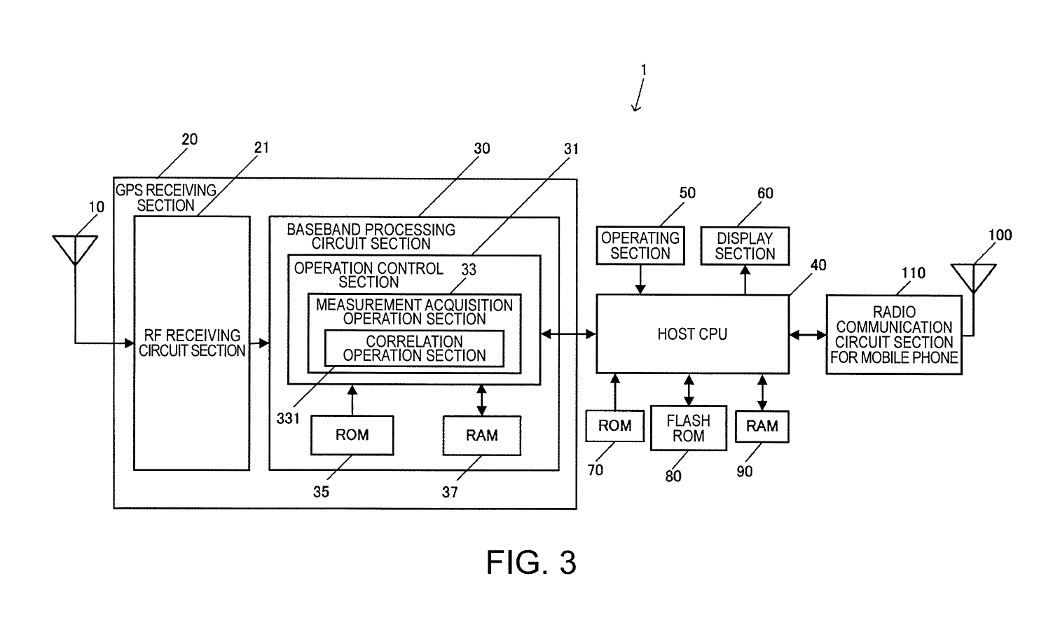

FIG. 3 is a block diagram showing the functional configuration of the mobile phone 1. The mobile phone 1 is configured to include a GPS antenna 10, a GPS receiving section 20, a host CPU (central processing unit) 40, an operating section 50, a display section 60, a ROM (read only memory) 70, a flash ROM 80, a RAM (random access memory) 90, a mobile phone antenna 100, and a radio communication circuit section 110 for a mobile phone.

The GPS antenna 10 is an antenna that receives an RF (radio frequency) signal including a GPS satellite signal transmitted from a GPS satellite, and outputs the received signal to the GPS receiving section 20. In addition, the GPS satellite signal is a communication signal with a frequency of 1.57542 [GHz] that is modulated by the direct spread spectrum method using a PRN (pseudo random noise) code which is a kind of different spread code for every satellite. The PRN code is a pseudo random noise code which has a code length of 1023 chips as 1 PN frame and has a repetition period of 1 ms.

The GPS receiving section 20 is a position calculation circuit which measures the position of the mobile phone 1 on the basis of a signal output from the GPS antenna 10 and is also a functional block equivalent to a so-called GPS receiver. The GPS receiving section 20 is configured to include an RF (radio frequency) receiving circuit section 21 and a baseband processing circuit section 30. In addition, the RF receiving circuit section 21 and the baseband processing circuit section 30 may be manufactured as separate LSIs (large scale integration) or may be manufactured as one chip.

The RF receiving circuit section 21 is a circuit block for RF signal processing and generates an oscillation signal for RF signal multiplication by dividing or multiplying a predetermined oscillation signal. Then, the RF signal is down-converted into a signal (hereinafter, referred to as an “IF (intermediate frequency) signal”) having an intermediate frequency by multiplying the RF signal output from the GPS antenna 10 by the generated oscillation signal, multiplication and the like of the IF signal are performed, and then the IF signal is converted into a digital signal by an A/D converter and output to the baseband processing circuit section 30.

The baseband processing circuit section 30 is a circuit section that captures and extracts a GPS satellite signal by performing correlation processing and the like on the IF signal output from the RF receiving circuit section 21 and that acquires a navigation message, time information, and the like by decoding the data. The baseband processing circuit section 30 is configured to include an operation control section 31, a ROM 35, and a RAM 37. In addition, the operation control section 31 is configured to include a measurement acquisition operation section 33.

The measurement acquisition operation section 33 is a circuit section that captures a GPS satellite signal from the received signal (IF signal), which is output from the RF receiving circuit section 21, and is configured to include a correlation operation section 331. The measurement acquisition operation section 33 acquires the information, such as the Doppler frequency or code phase of the captured GPS satellite signal, and outputs the information to the host CPU 40 as the measurement observation value.

The correlation operation section 331 captures the GPS satellite signal by performing the correlation operation processing for calculating and integrating the correlation between a PRN code and a replica code included in the received signal, for example, using the FFT (fast Fourier transform) operation. The replica code is a simulated signal of a PRN code which is generated in a pseudo manner and is included in a GPS satellite signal to be captured.

If a GPS satellite signal to be captured is correct, a PRN code and a replica code included in the GPS satellite signal will match each other (capture success). If it is wrong, the PRN code and the replica code included in the GPS satellite signal will not match (capture failure). Accordingly, it can be determined whether or not capturing of a GPS satellite signal has succeeded by determining the peak of the calculated correlation value. Thus, the GPS satellite signal can be captured by performing a correlation operation with the same received signal while sequentially changing the replica code.

In addition, the correlation operation section 331 performs the above-described correlation operation processing while changing the frequency and phase of the generated signal of the replica code. When the frequency of the generated signal of the replica code and the frequency of the received signal match each other and the phase of the PRN code and the phase of the replica code match each other, the correlation value is at a maximum.

More specifically, the range of predetermined frequency and phase corresponding to a GPS satellite signal to be captured is set as a search range. Then, a correlation operation in the phase direction for detecting the starting position (code phase) of a PRN code and a correlation operation in the frequency direction for detecting the frequency are performed within the search range. The search range related to the frequency is set within a predetermined frequency sweep range having 1.57542 [GHz], which is a carrier frequency of the GPS satellite signal, as a center frequency, and the search range related to the phase is set within a code phase range of 1023 chips which are the chip length of the PRN code.

The host CPU 40 is a processor which performs overall control of the sections of the mobile phone 1 according to various programs, such as a system program, stored in the ROM 70 and the flash ROM 80. In addition, the host CPU 40 determines the output position displayed on the display section 60 by measuring the position of the mobile phone 1 by performing the position calculation processing, generates a navigation screen on which the output position is plotted, and displays the navigation screen on the display section 60.

The operating section 50 is an input device configured to include a touch panel or a button switch, for example, and outputs a signal corresponding to a pressed key or button to the host CPU 40. By the operation of the operating section 50, various kinds of instruction input are performed, such as input of the destination or display request of the navigation screen.

The display section 60 is a display device formed by using an LCD (liquid crystal display), for example, and performs various kinds of display on the basis of a display signal input from the host CPU 40. A navigation screen, time information, and the like are displayed on the display section 60.

The ROM 70 is a read-only nonvolatile storage device and stores a system program which is used when the host CPU 40 controls the mobile phone 1, various programs or data used to realize a navigation function, and the like.

The flash ROM 80 is a readable and writable nonvolatile storage device and stores various programs, data, and the like, which are used when the host CPU 40 controls the mobile phone 1 similar to the ROM 70.

The RAM 90 is a readable and writable volatile storage device and forms the work area in which the system program executed by the host CPU 40, various processing programs, data being processed in various kinds of processing, a processing result, and the like are temporarily stored.

The mobile phone antenna 100 is an antenna used to perform transmission and reception of a radio signal for mobile phones between the mobile phone 1 and a base station provided by a communication service provider of the mobile phone 1.

The radio communication circuit section 110 for a mobile phone is a communication circuit section of a mobile phone configured to include an RF conversion circuit, a baseband processing circuit, and the like and realizes transmission and reception of a call or mail by performing modulation, demodulation, and the like of the radio signal for mobile phones.

### 3. Data Configuration

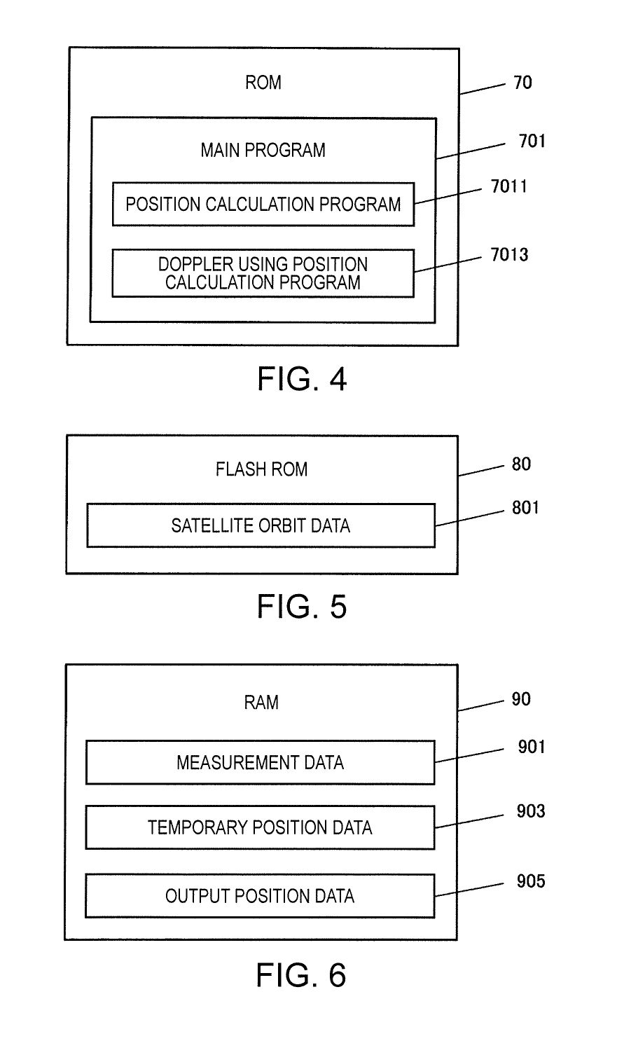

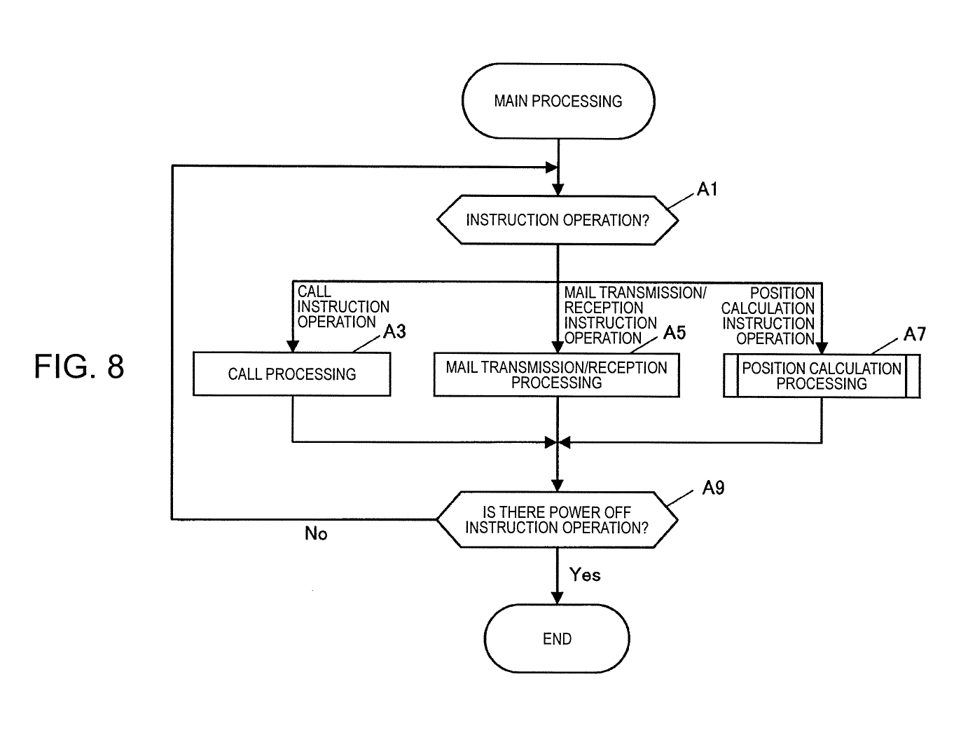

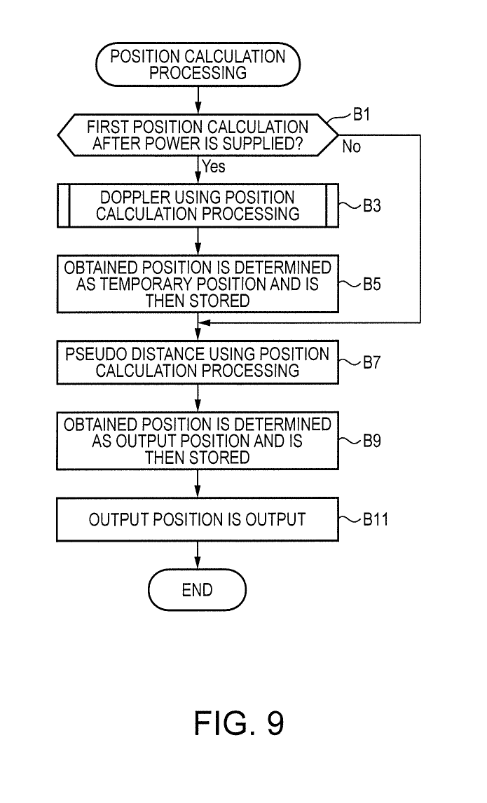

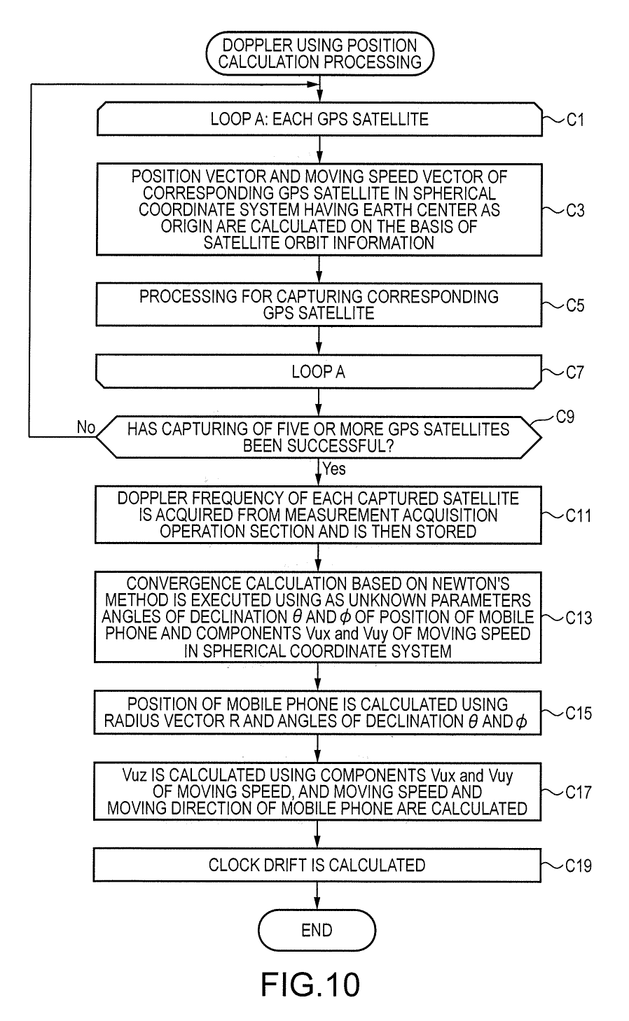

FIG. 4 is a view showing an example of data stored in the ROM 70. A main program 701 which is read by the host CPU 40 and is executed as main processing (refer to FIG. 8) is stored in the ROM 70. In addition, a position calculation program 7011 executed as position calculation processing (refer to FIG. 9) and a Doppler using position calculation program 7013 executed as Doppler using position calculation processing (refer to FIG. 10) are included as a subroutine in the main program 701.

The main processing includes not only the processing that the host CPU 40 performs for transmission and reception of a call or mail, which is an original function of the mobile phone 1, but also processing that the host CPU 40 performs in order to calculate the position of the mobile phone 1.

The position calculation processing is processing when the host CPU 40 determines the output position of the mobile phone 1 by performing position calculation processing using the pseudo distance (hereinafter, referred to as “pseudo distance using position calculation processing”) with the position calculated in the Doppler using position calculation processing as a temporary position, generates a navigation screen on which the output position is plotted, and displays the navigation screen on the display section 60.

In addition, the Doppler using position calculation processing is processing in which position calculation using the Doppler frequency of a GPS satellite signal is performed according to the principle described above. Details of the processing will be described later using a flow chart.

FIG. 5 is a view showing an example of the data stored in the flash ROM 80. Satellite orbit data 801 is stored in the flash ROM 80.

An almanac, in which data of approximate satellite orbits of all GPS satellites is stored, or an ephemeris, in which data of the detailed satellite orbit regarding each GPS satellite is stored, is included in the satellite orbit data 801. The satellite orbit data 801 may be acquired by decoding a GPS satellite signal received from a GPS satellite or may be acquired by server assistance from a base station, for example.

FIG. 6 is a view showing an example of data stored in the RAM 90. Measurement data 901, temporary position data 903, and output position data 905 are stored in the RAM 90.

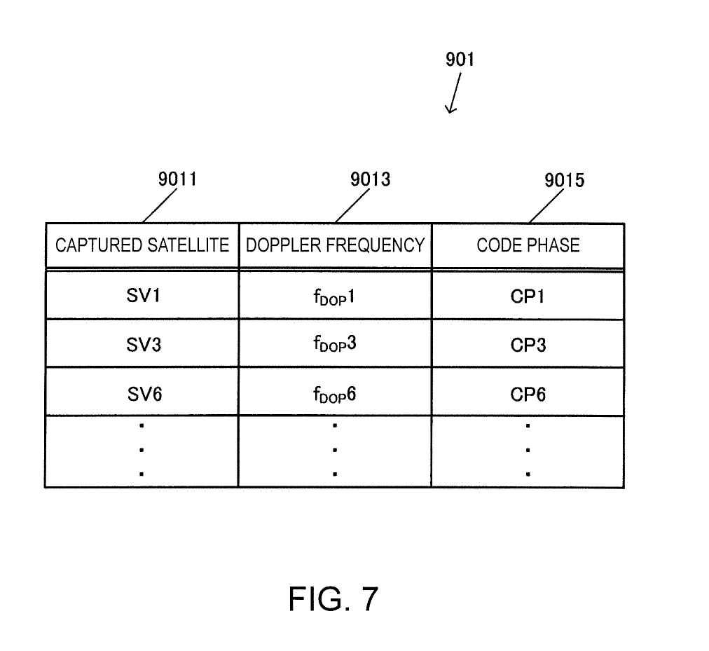

FIG. 7 is a view showing an example of the data configuration of the measurement data 901. In the measurement data 901, Doppler frequency 9013 and code phase 9015 of a GPS satellite signal received from the corresponding captured satellite are stored as measurement observation values so as to correspond with each other, for each captured satellite 9011. For example, for the measurement observation value regarding a captured satellite S1, the Doppler frequency is f_{DOP}1 and the code phase is CP1.

The temporary position data 903 is data of the temporary position of the mobile phone 1 obtained by performing the Doppler using position calculation processing. The temporary position is used as an initial position in pseudo distance using position calculation processing.

In addition, the output position data 905 is data of the output position of the mobile phone 1 obtained by performing the pseudo distance using position calculation processing.

### 4. Flow of Processing

FIG. 8 is a flow chart showing the flow of main processing executed in the mobile phone 1 when the main program 701 stored in the ROM 70 is executed after being read by the host CPU 40.

The main processing is processing which starts when the host CPU 40 detects that the user has performed a power supply operation through the operating section 50. In addition, although not particularly described, it is assumed that an RF signal is received through the GPS antenna 10 or down-converted to an IF signal by the RF receiving circuit section 21 and the IF signal is output to the baseband processing circuit section 30 as necessary while the following main processing is being executed. In addition, it is assumed that the Doppler frequency and code phase of a GPS satellite signal are calculated by the measurement acquisition operation section 33 as necessary.

First, the host CPU 40 determines an instruction operation that the user has performed through the operating section 50 (step A1). When the instruction operation is determined to be a call instruction operation (step A1; call instruction operation), call processing is performed (step A3). Specifically, the host CPU 40 prompts the radio communication circuit section 110 for a mobile phone to perform base station communication with a radio base station, so that a call between the mobile phone 1 and another apparatus is realized.

In addition, when it is determined that the instruction operation in step A1 is a mail transmission/reception instruction operation (step A1; mail transmission/reception instruction operation), the host CPU 40 performs mail transmission/reception processing (step A5). Specifically, the host CPU 40 prompts the radio communication circuit section 110 for a mobile phone to perform base station communication, so that transmission and reception of a mail between the mobile phone 1 and another apparatus is realized.

In addition, when the instruction operation is determined to be a position calculation instruction operation in step A1 (step A1; position calculation instruction operation), the host CPU 40 performs the position calculation processing by reading the position calculation program 7011 from the ROM 70 and executing it (step A7).

FIG. 9 is a flow chart showing the flow of the position calculation processing.

First, the host CPU 40 determines whether or not the position calculation is first position calculation after power is supplied to the mobile phone 1 (step B1). If it is determined that the position calculation is first position calculation (step B1; Yes), the host CPU 40 performs Doppler using position calculation processing by reading and executing the Doppler using position calculation program 7013 stored in the ROM 70 (step B3).

FIG. 10 is a flow chart showing the flow of the Doppler using position calculation processing. First, the host CPU 40 executes processing of loop A for each GPS satellite (steps C1 to C7). In the processing of the loop A, the host CPU 40 calculates the position vector and moving speed vector of the corresponding GPS satellite in the spherical coordinate system, which has the earth center as the origin, on the basis of the satellite orbit data 801 stored in the flash ROM 80 (step C3).

Then, the host CPU 40 performs capture processing for making the baseband processing circuit section 30 capture the corresponding GPS satellite (step C5). Then, the host CPU 40 performs the processing for the next GPS satellite. After performing the processing of steps C3 and C5 for all GPS satellites, the host CPU 40 ends the processing of the loop A (step C7).

Then, the host CPU 40 determines whether or not the capturing of the five or more GPS satellites was successful (step C9). When it is determined that the capturing of the five or more GPS satellites has failed (step C9; No), the process returns to step C1. In addition, when it is determined that the capturing of the five or more GPS satellites was successful (step C9; Yes), the host CPU 40 acquires the Doppler frequency of each captured satellite from the measurement acquisition operation section 33 and stores it in the measurement data 901 of the RAM 90 (step C11).

Then, using the Doppler frequency acquired in step C11 and using as unknown parameters the four parameters of the angles of declination θ and φ of the position vector of the mobile phone and the components vux and vuy of the moving speed vector in the spherical coordinate system, the host CPU 40 executes convergence calculation based on the Newton's method using the Expression (32) (step C13).

Then, the host CPU 40 calculates the position of the mobile phone 1 according to the Expression (7) using the radius vector R, which is expressed as a distance from the earth center to the earth's surface, and the angles of declination θ and φ acquired in the convergence calculation of step C13 (step C15).

Then, the host CPU 40 calculates vuz according to the Expression (12) using the components vux and vuy of the moving speed vector, which was acquired in the convergence calculation of step C13, and calculates the moving speed and moving direction of the mobile phone 1 (step C17).

Then, the host CPU 40 calculates a clock drift according to the Expressions (14) and (15) using the detected Doppler frequency and the position, moving speed, and moving direction of the mobile phone 1 calculated in steps C15 and C17 (step C19). Then, the host CPU 40 ends the Doppler using position calculation processing.

After performing the Doppler using position calculation processing, the process returns to the position calculation processing in FIG. 9 in which the host CPU 40 determines the obtained position as a temporary position of the mobile phone 1 and stores it in the temporary position data 903 of the RAM 90 (step B5). Then, the CPU 40 performs pseudo distance using position calculation processing (step B7).

In the pseudo distance using position calculation processing, the host CPU 40 calculates, for a plurality of captured satellites, the pseudo distance between the corresponding captured satellite and the mobile phone 1 using the code phase acquired by the measurement acquisition operation section 33. Then, using the calculated pseudo distance, the host CPU 40 performs position calculation using the least square method or the Kalman filter. In this case, the host CPU 40 performs the calculation using the temporary position, which is stored in the temporary position data 903 of the RAM 90, as the initial position.

After performing the pseudo distance using position calculation processing, the host CPU 40 determines the obtained position as the output position of the mobile phone 1 and stores it in the output position data 905 of the RAM 90 (step B9). Then, the host CPU 40 generates a navigation screen, on which the output position is plotted, and displays the navigation screen on the display section 60 (step B11). Then, the host CPU 40 ends the position calculation processing.

After returning to the main processing of FIG. 8 to perform the processing of one of the steps A3 to A7, the host CPU 40 determines whether or not the user has performed a power off instruction operation using the operating section 50 (step A9). When it is determined that the power off instruction operation has not been performed (step A9; No), the process returns to step A1. In addition, when it is determined that the power off instruction operation has been performed (step A9; Yes), the main processing ends.

### 5. Operations and Effects

The mobile phone 1 calculates the satellite position and satellite moving speed of each of a plurality of GPS satellites on the basis of the satellite orbit information in the spherical coordinate system having the earth center as the origin. In addition, the mobile phone 1 receives a GPS satellite signal from each of the plurality of GPS satellites to detect the Doppler frequency and calculates the position, moving speed, and moving direction of the user in the spherical coordinate system using the satellite position, satellite moving speed, and Doppler frequency of each of the plurality of GPS satellites under conditions in which the distance from the earth center to the earth's surface is set as a radius vector.

Specifically, a calculation expression for calculating the theoretical Doppler frequency regarding each of the plurality of GPS satellites is made using the satellite position, moving speed, and moving direction of each of the plurality of GPS satellites and the position, moving speed, and moving direction of the user, which are unknown quantities expressed in the spherical coordinate system, under conditions in which the distance from the earth center to the earth's surface is set as a radius vector. In this case, the calculation expression for calculating the Doppler frequency is made in consideration of the clock drift of the mobile phone 1.

In addition, for each of the plurality of GPS satellites, the position, moving speed, and moving direction of the user which are unknown quantities are calculated using the fact that the Doppler frequency calculated from the calculation expression of the theoretical Doppler frequency is equal to a Doppler frequency of a GPS satellite signal that is actually received.

For example, by fixing the radius vector R assuming that the user of the mobile phone 1 is located on the earth's surface and calculating the position of the user with the angles of declination θ and φ in the spherical coordinate system as unknown parameters, it becomes possible to appropriately calculate the position of the user using the Doppler frequency of the GPS satellite signal. In addition, this position calculating method can be easily applied to the product including the position calculating device.

Moreover, in the present embodiment, the moving speed and moving direction of the user are calculated assuming that a radial component in the spherical coordinate system is zero. By setting such constraints, the number of unknown parameters is reduced. As a result, the number of satellites required for position calculation can be reduced or the amount of operations can be reduced.

### 6. Modifications

### 6-1. Electronic Apparatus

The invention may be applied not only to the mobile phone but also to any kind of electronic apparatus as long as the electronic apparatus includes a position calculating device. For example, the invention may also be applied similarly to a notebook computer, a PDA (personal digital assistant), a car navigation apparatus, and a portable navigation apparatus.

### 6-2. Satellite Position Calculating System

In the above embodiment, an explanation has been made using a GPS as an example of a satellite position calculating system. However, other satellite position calculating systems may also be used, such as WAAS (wide area augmentation system), QZSS (quasi zenith satellite system), GLONASS (global navigation satellite system), and GALILEO.

### 6-3. Division of Processing

Some or all of processing that the host CPU 40 executes may be performed by the operation control section 31 of the baseband processing circuit section 30. For example, the operation control section 31 determines the output position by performing the position calculation processing using the measurement observation value (Doppler frequency and code phase) calculated by the measurement acquisition operation section 33 and outputs the output position to the host CPU 40. In addition, the host CPU 40 uses the output position input from the operation control section 31 for various applications.

### 6-4. Determination Regarding Suitability of Position

The suitability of the position calculated in the pseudo distance using position calculation processing may be determined using the position calculated in the Doppler using position calculation processing. In this case, a second position calculation program is stored in the ROM 70 as a subroutine of the main program 701. In addition, the host CPU 40 performs second position calculation processing by reading and executing the second position calculation program in the main processing.

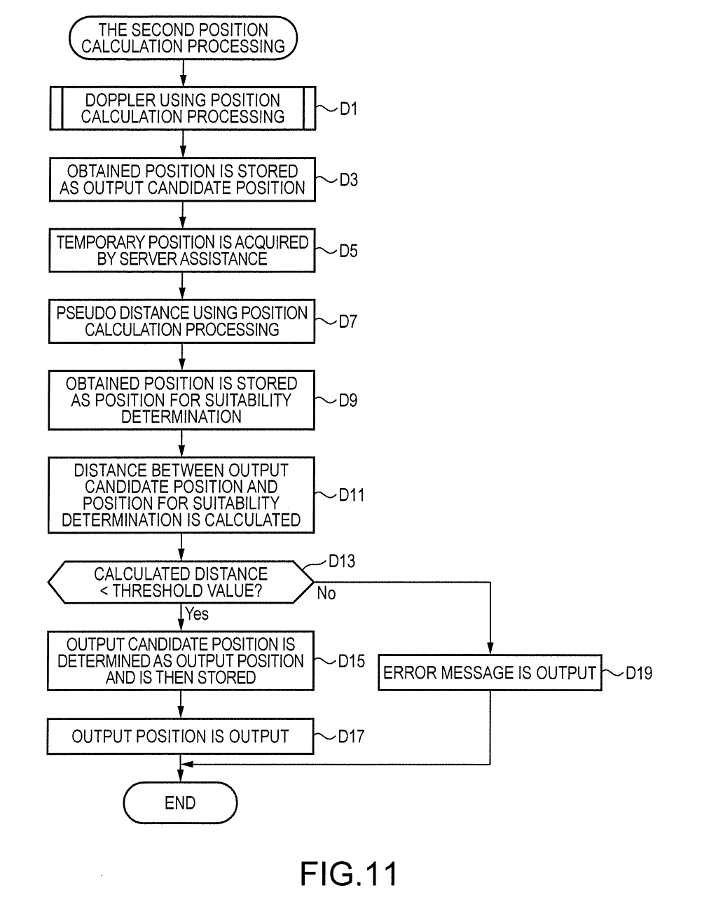

FIG. 11 is a flow chart showing the flow of the second position calculation processing. First, the CPU 40 performs Doppler using position calculation processing (step D1). Then, the host CPU 40 sets the obtained position stored in the RAM 90 as an output candidate position (step D3).

Then, the host CPU 40 acquires the temporary position of the mobile phone 1, for example, by server assistance (step D5). More specifically, the host CPU 40 acquires the approximate position of the mobile phone 1 from a communication base station by performing base station communication with the base station located within the communication range.

Then, the host CPU 40 performs pseudo distance using position calculation processing using the temporary position acquired in step D5 as the initial position (step D7). Then, the host CPU 40 makes the obtained position stored in the RAM 90 as a position for suitability determination (step D9).

Then, the host CPU 40 calculates the distance between the output candidate position and the position for suitability determination which are stored in the RAM 90 (step D11). Then, the host CPU 40 determines whether or not the calculated distance is less than a predetermined threshold value (for example, 1 km) (step D13). When it is determined that the calculated distance is less than the predetermined threshold value (step D13; Yes), the host CPU 40 determines that the output candidate position is suitable, determines the output candidate position as the output position, and stores it in the RAM 90 (step D15).

Then, the host CPU 40 generates a navigation screen, on which the output position stored in the RAM 90 is plotted, and displays the navigation screen on the display section 60 (step D17). Then, the host CPU 40 ends the second position calculation processing.

In addition, when it is determined that the distance between the output candidate position and the position for suitability determination is equal to or larger than the threshold value in step D13 (step D13; No), the host CPU 40 determines that the output candidate position is not suitable and displays, for example, an error message on the display section 60 (step D19). Then, the host CPU 40 ends the second position calculation processing.

What is claimed is:

1. A position calculating method comprising:
calculating the satellite position and velocity of a positioning satellite on the basis of satellite orbit information in an orthogonal coordinate system having the Earth center as the origin;
detecting a Doppler frequency by receiving a positioning signal from the positioning satellite; and
calculating the position of a position calculating device, which is an unknown quantity, using a calculation expression for calculating a theoretical Doppler frequency regarding the positioning satellite and a relational expression between clock drift of the position calculating device, which is an unknown quantity, and the detected Doppler frequency,
wherein the calculated satellite position and velocity of the positioning satellite, the position of the position calculating device which is an unknown quantity expressed in a spherical coordinate system in which the Earth center is the origin and a distance from the Earth center to the Earth's surface is a magnitude of a radius vector, and velocity of the position calculating device which are unknown quantities expressed in the orthogonal coordinate system are used in the calculation expression for calculating the theoretical Doppler frequency, and
in the calculating of the position of the position calculating device which is the unknown quantity, the number of unknown quantities is reduced by setting the magnitude of the radius vector as a fixed value, assuming that the radial component of the velocity of the position calculating device is zero, and eliminating the clock drift which is the unknown quantity using the relational expression regarding the plurality of positioning satellites.

2. A position calculating method comprising:
calculating the satellite position of a positioning satellite on the basis of satellite orbit information in an orthogonal coordinate system having the Earth center as the origin;
detecting a Doppler frequency by receiving a positioning signal from the positioning satellite; and
calculating the position of a position calculating device using the satellite positions of the plurality of positioning satellites and the Doppler frequency in a spherical coordinate system in which the Earth center is the origin and a distance from the Earth center to the Earth's surface is a magnitude of a radius vector.

3. The position calculating method according to claim 2, further comprising:
calculating the velocity of the positioning satellite on the basis of the satellite orbit information in the orthogonal coordinate system; and
calculating the velocity of the position calculating device in the orthogonal coordinate system using the satellite positions, velocities of the plurality of positioning satellites and the Doppler frequency.

4. The position calculating method according to claim 3,
wherein the calculating of the velocity of the position calculating device is performed assuming that the radial component of the velocity of the position calculating device is zero.

5. The position calculating method according to claim 3, further comprising:
calculating the position of the position calculating device, which is an unknown quantity, on the basis of the detected Doppler frequency and a calculation expression of a theoretical Doppler frequency using the satellite position and velocity of the positioning satellite, the position of the position calculating device which is the unknown quantity expressed in the spherical coordinate system, and velocity of the position calculating device which are unknown quantities expressed in the orthogonal coordinate system.

6. The position calculating method according to claim 5,
wherein in the calculating of the position of the position calculating device, clock drift of the position calculating device is further used as an unknown quantity.

7. The position calculating method according to claim 2, further comprising:
calculating the final position by performing predetermined position calculation processing based on the received positioning signal using the position of the position calculating device as the initial position.

8. A position calculating device comprising:
a satellite position calculating section that calculates the satellite position of a positioning satellite on the basis of satellite orbit information in an orthogonal coordinate system having the Earth center as the origin;
a Doppler detecting section that detects a Doppler frequency by receiving a positioning signal from the positioning satellite; and
a position calculating section that calculates the position of a position calculating device using the satellite position of the positioning satellite and the Doppler frequency in a spherical coordinate system in which the Earth center is the origin and a distance from the Earth center to the Earth's surface is a radius vector.
